(19) United States
(12) Patent Application Publication
(10) Pub. No.: US 2019/0024847 A1
(43) Pub. Date: Jan. 24, 2019

(54) LIQUEFIED FUEL GAS SYSTEM AND METHOD

(71) Applicant: SHELL OIL COMPANY, HOUSTON, TX (US)

(72) Inventors: William Ralph HUTCHINS, Kingwood, TX (US); Scott James Siebert HARTMAN, Houston, TX (US)

(21) Appl. No.: 16/066,592

(22) PCT Filed: Dec. 27, 2016
(86) PCT No.: PCT/EP2016/082687

§ 371 Date: Jun. 27, 2018

Related U.S. Application Data
(60) Provisional application No. 62/273,481, filed on Dec. 31, 2015.
(60) Provisional application No. 62/423,038, filed on Nov. 16, 2016.

(51) Int. Cl. F17C 7/04; F17C 1/00; F17C 13/00

(52) U.S. Cl. CPC F17C 7/04; F17C 2270/0171; F17C 13/004; F17C 2221/033; F17C 2223/0161; F17C 2223/033; F17C 2223/046; F17C 2225/0169; F17C 2225/033; F17C 2227/0135; F17C 2227/0157; F17C 2227/0178; F17C 2227/0355; F17C 2227/0393; F17C 2250/0439; F17C 2270/0105; F17C 1/005

(57) ABSTRACT

A method of fueling a transporter with liquefied fuel gas includes providing a transporter having a fuel gas storage tank for holding a liquefied fuel gas, a sub-cooler fluidly connected to the fuel gas storage tank, and a consumer. Liquefied fuel gas from the fuel gas storage tank is pumped into the subcooler to create subcooled liquefied fuel gas. The subcooled liquefied fuel gas may then be introduced into the fuel gas storage tank, for example by spraying into a vapor space of the fuel gas storage tank. Liquefied fuel gas is pumped from the fuel gas storage tank to provide pressurized liquefied fuel gas, the pressurized liquefied fuel gas is vaporized and the vaporized fuel gas is provided to the consumer for propelling the means of transport using the vaporized fuel gas as a fuel.

### TECHNICAL FIELD

The present disclosure relates generally to a liquefied fuel gas system and method for fueling a transporter with liquefied fuel gas. The transporter, or means of transport, may include, for instance, a truck, train or vessel. The liquefied fuel gas may include, but is not limited to, liquefied natural gas (LNG).

### BACKGROUND

With the number of people on our planet growing and living in cities, our roads, ports and airports are busier than ever. A range of vehicles and fuels will be needed to help meet this growing demand for transport. In the future, liquefied fuel gas, such as liquefied natural gas (LNG), could form a bigger part of the transport energy mix, alongside developments in areas such as greater vehicle efficiency, biofuels, hydrogen and electric mobility. LNG provides additional advantages in reducing CO2 emissions. Also, the use of LNG and other liquefied gasses as a fuel for transport typically also limits emissions of toxic flue gas components, such as carbon monoxide (CO), nitrogen oxides (NOx), and sulfur oxides (SOx), when compared with the use of conventional fuels such as bunker fuel.

Liquefying a fuel gas implies reducing the fuel gas to a liquid state. For example, cooling natural gas to around −162° C. (−260° F.) turns it into a liquid and shrinks its volume for easier shipment and storage. In recent years, the oil and gas industry has explored ways to broaden the use of LNG, from the traditional power generation sector to fuelling trucks, trains, and powering more of the world's growing commercial transport fleets and vessels.

LNG is already being used as a fuel for marine vessels on inland waterways, such as ferries in Norway, and has the potential to be used more widely by, for instance, cruise ships, tankers, bulk carriers, container vessels, ferries, barges, tug boats, product carriers, crude oil tankers, chemical carriers, roll-on/roll-off (RORO) ships, ConRo ships (Container/Roll-on Roll-off vessels), car carriers, multi-gas carriers, drill ships, semi-submersible drill rigs, and the like.

Beyond its use in fuelling marine transport, LNG also has the potential to be used in sectors such as rail and mining. Typically, the use of LNG may be preferred for long haul and/or substantially continuous transport.

As transport fleets and vessels transition to accepting LNG as a fuel source, there is a need for systems that are safe, cost-effective, reliable, and energy efficient. One of the problems faced by the industry in transitioning to LNG as a fuel source is vapor management. LNG containment systems have a limit on the allowable pressure build-up within the system as the LNG liquid heats up and transitions to an LNG vapor. LNG containment requires either active means to manage LNG vapor boil-off or the LNG fuelled vessel must be transported within a specific and finite time before the allowable pressure build-up is exceeded. Otherwise, LNG boil-off cannot currently be contained in a viable or economical manner.

In LNG fueled transport fleets and vessels, the vapor boil-off management becomes more important as the LNG is not being transported to a location but only used for consumption. Current proposals for vapor management of LNG fueled transports apply gas consumers or vapor re-liquefaction techniques in order to manage boil-off gas from the storage tanks.

U.S. Pat. No. 5,228,295 discloses a “no loss fueling station for liquid natural gas vehicles”. The fueling station comprises a storage tank for LNG, equipped with a pressure building circuit to ensure that the storage tank will always be operating under the minimum pressure required to ensure flow of LNG from the storage tank to the vehicle being refueled. The pressure building circuit comprises a vaporizer coil (heat exchanger) to vaporize the LNG therein to deliver it to the head (vapor space) of the storage tank as a gas. A pressure regulator is provided in the circuit to allow LNG to be vaporized when it senses a pressure in the vapor space below the desired minimum. A circulation loop is provided to sub-cool the pump, eductor and meter prior to delivering LNG to the vehicle in order to ensure that vaporized natural gas is not delivered to the use device. In an alternate embodiment a heat exchanger using LN2 or other coolant can be used in place of the pump to sub-cool the LNG.

However, U.S. Pat. No. 5,228,295 does not solve the problem of changing gas composition due to differences in boil-off between respective fractions of the liquefied gas. LNG is a mixture of hydrocarbon gases, all of which have varied boiling points. Under conditions of ordinary storage in a tank, from which some of the liquefied gas is allowed to boil off, fractionation of the mixture of the gases takes place in the storage tank, due to the different boiling points of the respective gases. The higher boiling point constituents vaporize less readily than those of lower boiling point, which produces a boil-off product having a lower B.t.u. content and a different composition from the liquid inventory remaining in the tank.

U.S. Pat. No. 3,302,416 provides a system for storing LNG in large onshore storage tanks and for rendering the stored LNG substitutable with pipeline gas. Herein, liquid is withdrawn from the storage reservoir from a region near the bottom of the reservoir. The withdrawn liquid is subcooled, and the liquid is returned to the main liquid body in such fashion as to maintain the temperature of the liquid substantially uniform throughout its volume and at a level such that no boiloff can occur. The sub-cooled inventory is preferably returned below the liquid level under normal operation in order to maintain nearly uniform temperature conditions throughout the stored liquid; however, if more immediate response is needed to a rising pressure in the tank, means are provided for diverting the sub-cooled liquid through a valve and spraying it into the vapor space to more abruptly reduce the pressure within the tank. The total volume of liquid is not subcooled, but is maintained at equilibrium temperature at substantially ambient atmospheric pressure, so that the difference between the external and internal pressure on the storage reservoir is reduced to a minimum.

The system of U.S. Pat. No. 3,302,416 is however unsuitable for use on transports, such as vessels and trucks. The system includes a nitrogen refrigeration circuit, which requires make-up gas to make up for lost nitrogen, which may be unacceptable in some locations due to environmental concerns or regulation. The system of U.S. Pat. No. 3,302,416 is relatively complex, resulting in relatively high up-front investment costs (CAPEX) and increased weight of the overall equipment.

Consequently, conventional transports, such as LNG fueled vessels, have been applying gas consumers to burn the boil-off gas, which typically have limited efficiency at lower speeds of the transporter, or vapor re-liquefaction techniques, which require relatively expensive equipment.

### BRIEF SUMMARY

In accordance with at least one aspect of the present disclosure, there is provided a method of fueling a transporter with liquefied fuel gas, the method comprising the steps of:

providing a transporter, the transporter comprising a fuel gas storage tank for holding a liquefied fuel gas, a sub-cooler fluidly connected to the fuel gas storage tank, and a consumer;

pumping liquefied fuel gas from the fuel gas storage tank into the sub-cooler to create subcooled liquefied fuel gas; and

introducing the subcooled liquefied fuel gas into the fuel gas storage tank.

In an embodiment, the step of introducing the subcooled liquefied fuel gas into the fuel gas storage tank comprising spraying the subcooled liquefied fuel gas into a vapor space of the fuel gas storage tank.

In another embodiment, the method further comprises the steps of:

pumping the liquefied fuel gas from the fuel gas storage tank to provide pressurized liquefied fuel gas;

vaporizing the pressurized liquefied fuel gas to provide vaporized fuel gas; and

providing the vaporized fuel gas to the consumer for propelling the means of transport using the vaporized fuel gas as a fuel.

In an embodiment, the method comprises the further steps of:

monitoring the temperature of the liquefied fuel gas in the fuel gas storage tank;

introducing the subcooled liquefied fuel gas into the fuel gas storage tank when said temperature exceeds a predetermined upper threshold; and

stopping with introducing the subcooled liquefied fuel gas into the fuel gas storage tank when said temperature drops below a lower threshold.

The upper threshold may be about 0.25° C. below a boiling temperature of the liquefied fuel gas. The lower threshold may be about 1° C. below a boiling temperature of the liquefied fuel gas.

According to another aspect, the disclosure provides transporter, comprising:

a fuel gas storage tank for holding a liquefied fuel gas;

a sub-cooler fluidly connected to the fuel gas storage tank to provide subcooled liquefied fuel gas and re-introduce the subcooled liquefied fuel gas into the fuel gas storage tank; and

a consumer.

In an embodiment, the transporter further comprises:

a pump for pumping the liquefied fuel gas from the fuel gas storage tank to provide pressurized liquefied fuel gas;

a vaporizer for vaporizing the pressurized liquefied fuel gas to provide vaporized fuel gas; and

the consumer comprising an engine using the vaporized fuel gas as a fuel for propelling the transporter.

In another embodiment, the consumer is a gas fueled engine adapted to power the transporter.

In an embodiment, the transporter is selected from the group of transport vessels, trains, and trucks.

The transported may comprise a spray header arranged in the fuel gas storage tank for spraying the subcooled liquefied fuel gas into the fuel gas storage tank.

In an embodiment, the sub-cooler may comprise a compressor, a turbine, a first heat exchanger, and a second heat exchanger. The sub-cooler may be adapted to use a closed Brayton refrigeration cycle. The sub-cooler may be adapted to use a Turbo-Brayton refrigeration cycle.

According to yet another aspect, the disclosure is directed to the use of a subcooling system for fueling a transporter with liquefied fuel gas, the use comprising the steps of:

providing a transporter, the transporter comprising a fuel gas storage tank for holding a liquefied fuel gas and a consumer, with a sub-cooler;

fluidly connecting the sub-cooler to the fuel gas storage tank;

pumping liquefied fuel gas from the fuel gas storage tank into the sub-cooler to create subcooled liquefied fuel gas; and

introducing the subcooled liquefied fuel gas into the fuel gas storage tank.

The disclosure provides a fuel gas supply and transfer system wherein the system is capable of fueling a transport vessel with liquefied natural gas (LNG). Aspects of the present disclosure may be applied to an LNG conversion, where a diesel fueled engine is converted to accept LNG as a fuel source.

In at least one implementation of the present disclosure, a method is presented for controlling the boil-off rate of LNG vapor in an LNG tank located on an LNG fueled transport. The method includes the step of pumping liquefied natural gas (LNG) from the LNG tank into a subcooler, wherein the subcooler is located on the LNG fueled transport. The method also includes reintroducing subcooled LNG into the LNG tank to control the boil-off rate of the vapor in the LNG tank.

The system(s) and method(s) disclosed herein include a novel means for subcooling the LNG. The system(s) and method(s) presented herein address the problem of vapor management with a solution that subcools a portion of LNG from the LNG tank with a subcooler that is located on the LNG fuelled vessel. In accordance with the novel system(s) and method(s) disclosed herein, the vapor pressure in the LNG tank is reduced by reintroducing the subcooled LNG into a spray system at the top of the LNG tank.

Unlike previously known systems and methods that manage LNG vapor boil-off by routing the LNG vapor through a vapor compressor and auxiliary consumers, the system(s) and method(s) disclosed herein subcools the LNG on the transport vessel to create a more economical, reliable, and consistent solution to the problem of vapor management.

In accordance with at least one implementation of the present disclosure, a method disclosed herein prevents weathering of the LNG by preserving the composition of the gas, causing minimal (or zero) change to the composition, and allowing the quality of the LNG fuel to remain within the calorific value required by the engine manufacturer.

By subcooling the LNG liquid in accordance with at least one aspect of the present disclosure, the system(s) and method(s) provided herein are preferably adapted to maintain a near-constant LNG heating value during the time the LNG is in the tank. At least one implementation of the system and method presented herein is also preferably adapted to allow the LNG fueled transport to maintain constant fuel consumption. This is not possible where vapor removal occurs, as the composition of the LNG will change due to differences in boiling points of respective components of the liquefied gas.

The present disclosure increases the efficiency and safety of LNG fueled transports during transfer of LNG from a discharging tank to a receiving tank on the LNG fueled transport by providing the ability to lower the temperature of any LNG remaining in the receiving tank before transfer and thereby limiting flashing in the receiving tank during transfer.

In one aspect, at least one implementation of the system and method provided herein increases the storage capacity of LNG liquid in the LNG tank by providing constant and continuous management of the LNG vapor.

The system and method provided by the present disclosure lowers the overall cost of an LNG fuel gas supply and transfer system by eliminating additional gas consumers currently required for vapor management.

### BRIEF DESCRIPTION OF THE DRAWINGS

For a more detailed understanding of the invention as claimed, reference is made to the accompanying illustration, wherein:

FIG. 1 depicts a diagram indicating examples of the change in methane number (MN) over time (horizontal axis) for lean LNG and rich LNG respectively, when using said LNG to fuel a conventional vessel;

FIG. 2 depicts a cross sectional view of a transport vessel provided with a system in accordance with an embodiment of the present disclosure, moored alongside a bunker vessel;

FIG. 3 depicts a diagram of an embodiment of a system in accordance with the present disclosure;

FIG. 4 depicts a diagram of a detail of an embodiment of a system in accordance with the present disclosure;

FIG. 5 depicts a diagram of an embodiment of a closed Brayton cooling cycle used in an embodiment of a method in accordance with the present disclosure; and

FIG. 6 depicts a diagram indicating an example of the closed Brayton cooling cycle, indicating temperature (T) versus entropy (s) at constant pressure of an embodiment of a cooling cycle as included in an embodiment of a method in accordance with the present disclosure.

### DETAILED DESCRIPTION

LNG is a mixture of hydrocarbon gases, all of which have varied boiling points. Under conditions of ordinary storage in a tank, from which some of the liquefied gas is allowed to boil off, fractionation of the mixture of the gases takes place in the storage tank, due to the different boiling points of the respective gases. The higher boiling point constituents vaporize less readily than those of lower boiling point, which produces a boil-off product having a lower B.t.u. content and a different composition from the liquid inventory remaining in the tank. Examples of LNG composition are provided in the table below, for exemplary compositions of “rich” LNG (i.e. LNG comprising substantial amounts of components heavier than methane, such as Ethane and Propane) and “lean” LNG (comprising modest amounts of heavier components).

Typical LNG fuel system designs incorporate vapor removal as a means to manage boil off gas (BOG) within an LNG fuel tank. This vapor removal method has been used successfully on board LNG carriers and has been accepted as common practice by LNG vessel design teams. LNG as fuel systems are differentiated from the typical LNG carrier designs by the tank volume and relative boil off rate (BOR). Typical LNG carriers have a BOR of about 0.15% per day or less on relatively large tanks, where the volume is typically greater than 25,000 cubic meters. LNG fuel systems have utilized LNG fuel tanks with volumes nearing ten times less and boil off rates much higher, with some nearing boil off rates of 0.45% up to 1% per day for smaller tanks, which are typical when the LNG is used as a fuel only.

LNG fuel vessels are also not in the LNG trade where they are moving LNG as a cargo but the LNG is being utilized as a fuel and is now being used at the end of a supply chain rather than being in the middle of a supply chain where the end use happens after redelivery to a storage tank. This presents an issue where the volume of the LNG fuel tank is in a constant gradual change versus a LNG vessels storage tank where it is typically full or empty. This gradual change coupled with relatively high BOR and vapor removal introduces a magnified issue of LNG weathering and subsequent gas compositional change when the LNG is used as a fuel for transporting a cargo other than LNG.

LNG weathering phenomena has been known to the industry and have been managed without changing methodology of vapor removal from storage tanks. This happens when the lighter components in the composition boils off before the heavier components, resulting in a change of the overall gas composition. Further examination of the gas compositional changes on LNG fuel tanks has shown significant gas compositional changes not before seen in larger LNG vessels moving LNG as a product and not as a fuel. Since the LNG in a LNG fuel system is being used at the end user point, there is no chance to correct or change the gas composition to ensure its suitability in the end consumer.

Engine manufacturers utilising LNG as a marine fuel stipulate, among other gas compositional requirements, lower heating value (LHV), higher heating value (HHV), and methane number (MN) requirements of LNG as a marine fuel to be within certain values. If LNG is loaded at or near the engine manufacturer minimum requirements there is a possibility of the LNG gas compositional change during the gradual use of the fuel on board a LNG fuelled vessel falling outside of the engine manufacturer's requirement. The result would be the marine fuelled engine would experience sub-optimal performance, increased fuel consumption, possible knocking, misfiring, and engine derating due to excessive exhaust gas temperatures, and potential overheating and/or damage to internal engine components such as piston crowns and exhaust valves.

The so-called methane number (MN) is for instance used to quantify the quality of the natural gas. An optional methane number specification for a natural gas engine satisfies both the need to control fuel variability according to the requirements as set by the engine manufacturer and allows more flexibility in fuel composition. Several manufacturers of heavy-duty natural gas engines use either the methane number (MN) or motor octane number (MON) to specify gas quality requirements. Both the MON and the MN are measures of the knock resistance of the fuel with the difference being the reference fuels used.

The methane number may be derived experimentally, correlating the engine performance and fuel gas composition. A 100% methane composition is given methane number 100. As the percentage higher hydrocarbons increases, the methane number decreases. Every natural gas engine has a minimum methane number to prevent engine knocking. For most of the gas engines, the minimum methane number is about 80, but can vary between 65 to 85 depending on the type of engine and the manufacturer.

A study has shown LNG gas compositional changes in a 2,400 cubic meter tank with a typical insulation system having a BOR of about 0.45% per day over a period of 100 days. The study looked at two cases of LNG gas compositions of a rich LNG case and a lean LNG case, where the compositions are as indicated in the following table.

| | Rich LNG | Lean LNG |
|---|---|---|
| Methane Number (AVL) | 74.21 | 93.75 |
| HHV (Btu/scf) | 1111 | 1023 |
| Components | Mol. % | Mol. % |
| Methane | 87.62 | 98.487 |
| Ethane | 10.07 | 1.186 |
| Propane | 1.55 | 0.135 |
| Isobutane | 0.10 | 0.022 |
| n-Butane | 0.11 | 0.023 |
| Isopentane | | 0.006 |
| n-Pentane | | 0.003 |
| n-Hexane | | 0.002 |
| CO2 | | 0.006 |
| Nitrogen | 0.55 | 0.131 |
| Total Composition | 100.00 | 100.000 |
| Avg. MW (g/mol) | 17.96 | 16.27 |

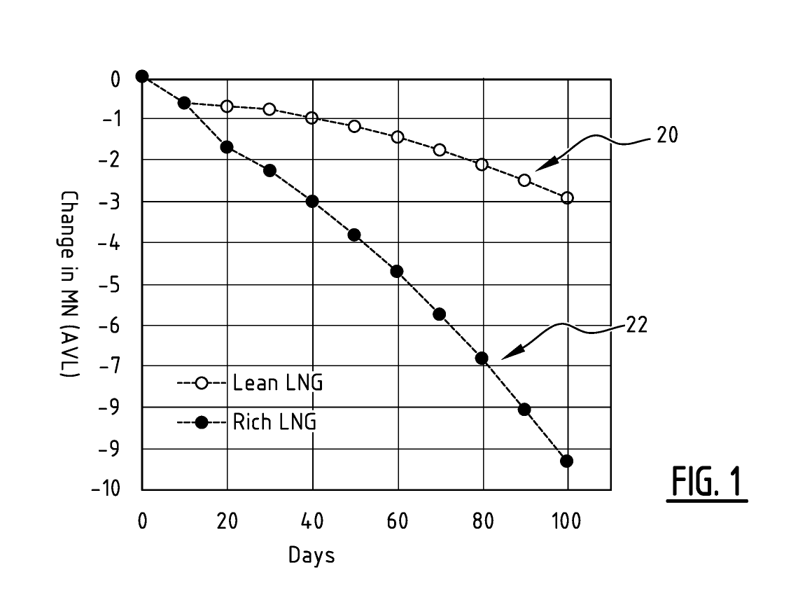

The diagram of FIG. 1 shows an exemplary indication how the methane number of the liquefied gas (vertical axis) drops over time (horizontal axis). For lean LNG, line 20 indicates that over a 100 day journey, the methane number may drop for instance in the order of 3, which is in the range of 3 to 10%, for instance about 5%, of the methane number at the start of the journey. For rich LNG, line 22 indicates that the drop in methane number is typically more prominent, indicating a drop in the order of 9 to 10 over a 100-day journey. The latter is in the range of a 10 to 15% drop compared to the methane number at the start of the journey. And as previously discussed, the lower the volume of the fuel tank the greater the change can be expected in the gas composition.

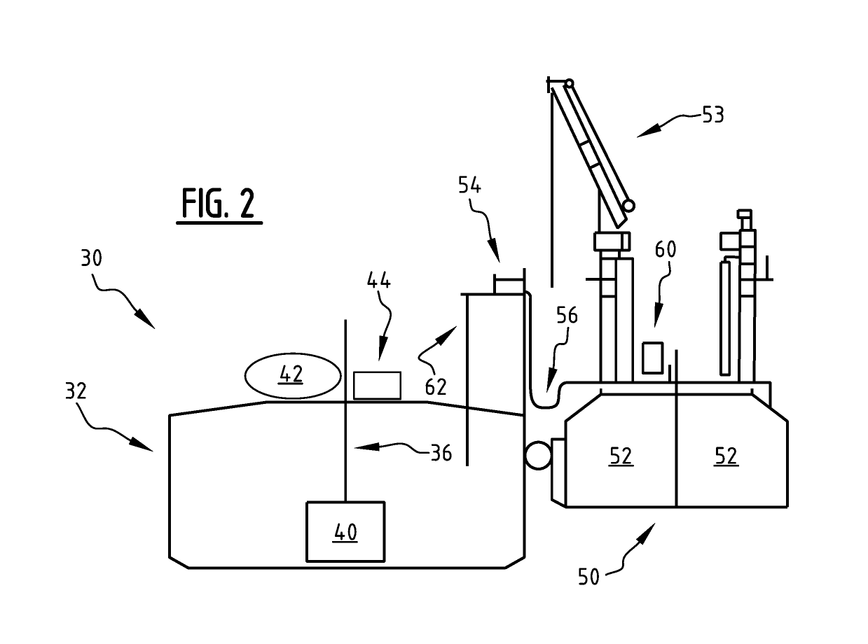

FIG. 2 depicts a transporter, such as a transport vessel 30, comprising a hull 32, a storage space 34 for cargo inside the hull, an optional bulkhead 36, at least one engine 40 for propelling the vessel 30, and at least one fuel tank 42. The engine 40 is a gas fueled engine. The storage tank 42 is a tank for storing liquefied fuel gas, such as LNG. The vessel 30 may also be provided with subcooler 44 for receiving and subcooling liquefied fuel gas from the tank 42.

The transport vessel 30 is moored alongside a bunker vessel 50 to take in liquefied gas as fuel. The bunker vessel typically comprises one or more storage tanks 52 for liquefied gas, a crane 53 (optional), a bunker manifold 54, a hose 56 for supplying the liquefied gas from the storage tanks 52 of the bunker vessel to the storage tank of the transport vessel 30.

For refueling, the transport vessel 30 is moored alongside the bunker vessel 50, as shown in FIG. 2. A bunker fill line 62, for instance a hose or tube, of the transport vessel is coupled to the bunker manifold to enable re-fueling. Liquefied fuel gas is pumped from the storage tanks 52 via the hose 56 and bunker fill line 62 to the fuel tank 42 on the vessel 30.

In a preferred embodiment, the bunker vessel is provided with a subcooler 60. Herein, when refueling the vessel 30 the liquefied fuel gas is first pumped from the storage tanks 52 to the subcooler to be subcooled to a lower temperature. Subsequently, the subcooled liquefied fuel gas is pumped to the storage tank 42 on the vessel 30. The liquefied gas is typically stored at about atmospheric pressure. The liquefied gas is typically stored at atmospheric pressure. The temperature of the liquefied gas at atmospheric pressure is about the boiling point. For LNG, the temperature of the stored LNG is typically around −162° C. (−260° F.). Subcooling the liquefied gas to a lower temperature before pumping it to the fuel tank 42 on the vessel prevents flashing, i.e. the rapid evaporation of the liquefied gas either in the cryogenic hose 56 or in the fuel tank 42. This makes refueling safer and prevents loss of the fuel. Lower temperature herein may indicate a reduction in temperature in the range of 0.5 to about 3 degrees below the boiling temperature of the liquefied gas. This is sufficient to provide the advantages indicated above, while limiting the energy required to sub-cool the liquefied gas.

The system of the present invention can be retro-fitted to an existing vessel. This may obviate problems with knocking, lengthen the potential journey time, and/or expand the range of suitable fuels.

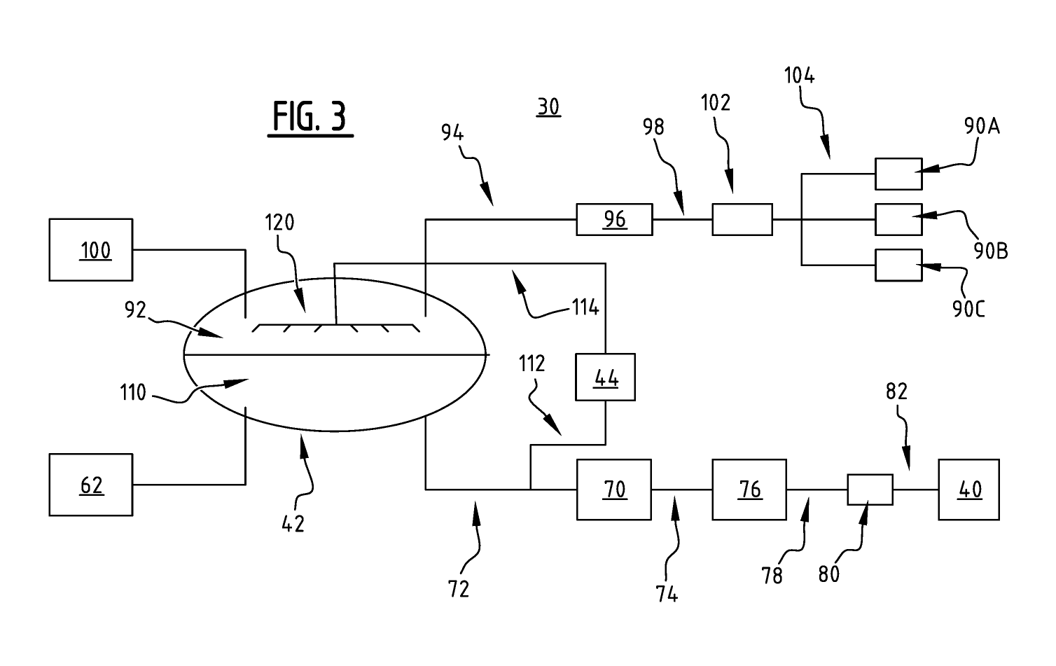

FIG. 3 shows a typical diagram of a transport vessel driven by liquefied gas. The vessel comprises the storage tank 42 for liquefied gas. In an embodiment, the liquefied gas is provided from the storage tank 42 to a high pressure pump 70 via cryogenic conduit 72. To move the vessel, the high pressure pump pumps the liquefied gas via conduit 74 to a vaporizer 76. The vaporizer vaporizes the liquefied gas, and provides the gas vapor 78 to the engine 40. A pressure control valve 80 may typically be arranged between the vaporizer and the engine, to control the vapor pressure and/or to control the amount of gas 82 supplied to the engine in correspondence with engine demand.

A conventional liquefied gas driven transporter may typically comprise a number of auxiliary circuits. These auxiliary circuits could comprise for instance, as indicated in FIG. 3, one or more auxiliary gas consumers 90A, 90B, 90C. The auxiliary consumers may comprise one or more engines for propulsion or for driving electricity generators. The auxiliary consumers 90A-90C are typically connected to a vapor space 92 connected of the fuel tank 42 via gas conduit 94. The auxiliary circuit may comprise a vapor compressor 96 to compress the gas vapor and provide compressed vapor 98 to the consumers 90A-90C. A pressure control valve 102 may be included to control and regulate the pressure of the regulated vapor 104 provided to the consumers 90A-90C. In addition, other vapor control circuits may be provided, such as a vapor return circuit 100.

In accordance with an embodiment of the disclosure, the transporter is provided with a sub-cooler 44. The sub-cooler may receive liquefied fuel gas from the fuel tank 42 via conduit 112. The conduit 112 may be connected to the conduit 72, or directly to the liquefied gas space 110 of the fuel tank 42. The sub-cooler 44 sub-cools the liquefied gas to provide sub-cooled liquefied gas. The sub-cooled liquefied gas 114 is returned to the fuel tank, preferably by spraying the sub-cooled liquefied gas into the vapor space 92 of the tank 42 via spray nozzles 120.

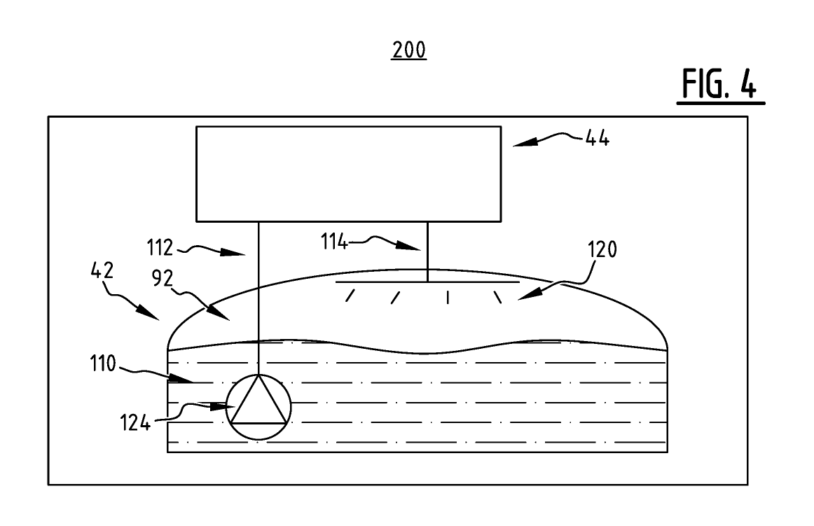

FIG. 4 shows another embodiment of the system 200 of the disclosure, wherein the sub-cooler 44 is directly connected to the fuel tank 42. A pump 124 may be submerged in the liquefied fuel, to pump the liquefied gas to the sub-cooler unit 44.

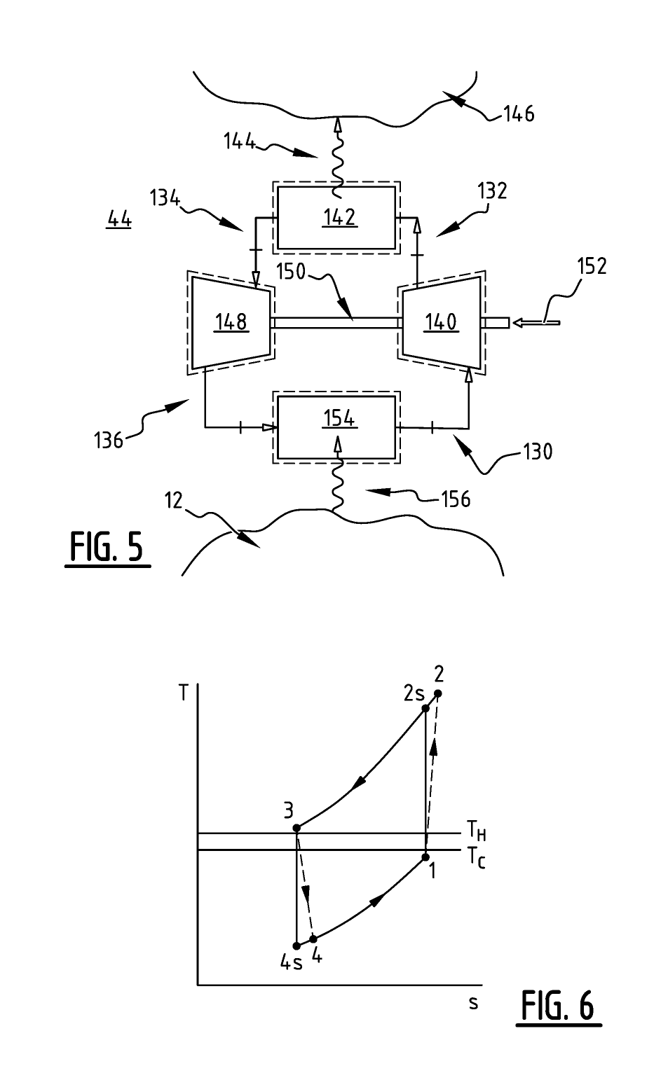

FIG. 5 shows a preferred embodiment of the sub-cooler system 44 using a Brayton cycle. The sub-cooler 44 comprises a number of components connected by a loop of working fluid conduits 130, 132, 134, 136, filled with a suitable working fluid. FIG. 6 shows the corresponding temperature T (vertical axis) versus specific entropy s (horizontal axis) at respective positions 1, 2, 3, 4 along the loop. The components may include a compressor 140 to receive the working fluid and compress it to a higher pressure and corresponding increased temperature. In a first heat exchanger 142, the compressed working fluid releases heat 144 to a heat sink 146 at substantially constant pressure. The heat sink should have a lower temperature than the working fluid at location 2. For instance, for a vessel the heat sink 146 is typically cooling water taken in from the body of water on which the vessel happens to be. A turbine 148 receives the compressed and cooled working fluid from the first heat exchanger 142. The compressed working fluid expands, driving the turbine 148. In the preferred embodiment, the turbine may be connected to the compressor 140 via corresponding drive axis 150, limiting the external power 152 required to drive the compressor 140. The expanded working fluid is provided to a second heat exchanger 154 for drawing heat 156 from a cold region, such as the liquefied gas in the conduit 112. This makes the cold region colder than before. With a properly selected working fluid, this cycle enables to cool the liquefied gas below its boiling temperature, sub-cooling it.

The sub-cooler 44 will be used to control the temperature of the LNG in the storage tank 42. When in time, the storage tank starts absorbing heat (temperature rise), the system of the invention will be activated to cool down the LNG back to −162° C., which consequently also results in change of vapor pressure. If temperature drops below −162° C., there will be some slight sub-atmospheric pressure in the vapor space 92 of the tank. The liquid LNG 112 is subcooled by several degrees (for instance depending on the flow rate of the LNG, as controlled by the pump 124 or by a valve (not shown)). The sub-cooled LNG 114 is sent back inside the tank by spraying into the vapor space. Spraying this subcooled liquid is a way to regulate the pressure of the vapor phase of the tank.

In a preferred embodiment, the sub-cooler 44 is a Turbo-Brayton unit. The Turbo-Brayton sub-cooler is a design of Air Liquide and it is based on a “closed Brayton cycle”. In the Brayton refrigeration cycle, the working fluid remains a gas throughout the system and a turbine is used instead of an expander, as shown in FIG. 5. The work developed by the turbine assists in driving the compressor.

In a practical embodiment, the refrigerant gas used in the subcooler is Nitrogen, Helium or a mixture thereof. In principal one could achieve the same duty with an additional stage of vapor-compression refrigeration. However, the benefit of the Turbo-Brayton is the improved reliability (magnetic bearings of the common axis 150) and reduced maintenance. The higher price is offset by the reliability performance, which is preferred to limit downtime during long haul transport.

In a practical embodiment, the system of the disclosure reduces the temperature of the liquefied gas in the storage tank 42 in the order of 0.25 to 1 K/° C. This modest temperature reduction is sufficient to maintain the LNG methane number within 1 to 2% of the original methane number over prolonged periods of time, exceeding 100 days, while minimizing required cooling duty. Thus, the system of the invention provides significant benefits over conventional options such as re-liquefying boil off gas.

It is also possible to cool the liquefied gas much more. For instance, the system of the disclosure can cool LNG in the tank 42 to −182° C. temperatures, with the cooling capacity limited to prevent continuous crystallization.

The system and method including the sub-cooler 44 in accordance with the present disclosure may eliminate the need for part or all of the auxiliary circuit (see FIG. 3), such as the vapor compressor 96, pressure control unit 102 and auxiliary consumers 90A-90C.

In an embodiment, the system of the present disclosure may be retro-fitted to an existing transport vessel. For instance, an existing transport vessel equipped with one or more gas fuelled engines may be provided with the sub-cooler and spray nozzles, providing all the benefits of the present disclosure.

Moreover, it is contemplated that the function of the subcooler 44 in accordance with the present disclosure may also eliminate the need for the vapor return 100.

In an embodiment, the LNG Tank 42, the subcooler 44, the main consumer line (i.e., the high pressure pump 70, the vaporizer 76, the pressure control valve system, and the main consumer 40, are all located on the LNG fueled transporter.

The optional high pressure pump 70 is preferably adapted to pressurize the LNG for the main consumer 40, typically an LNG fueled engine.

By subcooling a portion of the LNG liquid that would otherwise be used by the main consumer 40 and reintroducing the subcooled LNG through a spray header 120 in the vapor space 92 of the LNG Tank 42, LNG vapor in the LNG Tank 42 is cooled and the vapor pressure within the LNG Tank 42 is thereby reduced. The process of subcooling and reintroducing will allow constant and continuous management of vapor. After repeated iterations of the hereinbefore described process, the LNG liquid in the liquid space 110 of the LNG Tank 42 will eventually reduce in temperature thereby not allowing boil-off gas to occur.

In an example operation where LNG is transferred to the LNG Tank 42 to fill, or refill, the LNG Tank 42, the system and method described herein for actively subcooling the liquid in the fuel tank 42 will allow for a safer, more rapid, and less complex transfer of LNG when compared to traditional passive cooling techniques.

Conventional systems relied on passive cooling, which uses the relatively colder temperature of the LNG that is transferred into the LNG tank to cool the LNG tank. This passive cooling method leads to flashing in the LNG tank, which generates LNG vapor and vapor pressure that must be managed, leading to long filling rates. Active subcooling in accordance with the present disclosure, using the subcooler 60, allows for preparation of the receiving LNG Tank 42 before the time of transfer, thereby allowing a less complex and more rapid LNG transfer. The method and system according to the present disclosure will enable LNG transfers to be more like traditional liquid transfers, and speed up the filling rate compared to the traditional passive cooling techniques.

For example, during a transfer operation wherein the LNG Tank 42 is actively cooled in accordance with the present disclosure, LNG can be transferred from an LNG supply source, such as a discharging tank 52, to the receiving LNG Tank 42 on the LNG fueled transporter 30, via the Bunker Fill Line 56. Any remaining LNG liquid in the receiving LNG Tank 42 may be routed through the sub-cooler 44 to create subcooled LNG and reintroduced into the receiving LNG Tank 42 through the spray system 120 in the vapor space of the receiving LNG Tank 42 to lower the temperature of the LNG liquid in the receiving LNG Tank 42. As a result of subcooling, the temperature difference between the LNG being transferred into the receiving LNG Tank 42 and the temperature of the LNG already in the receiving LNG Tank 42 can be within a minimal enough of a difference to prevent flashing in the receiving LNG Tank 42 during transfer. Said temperature difference is, for instance, within 0.25 to 1 K.

In an example operation where LNG is supplied to a main consumer 40, such as an LNG fueled engine, the system and method described herein effectively preserve the composition of the LNG fuel, causing minimal (or zero) change to the LNG fuel composition, and allowing the quality of the LNG fuel to remain within the engine manufacturer's requirements.

In a traditional supply operation, where LNG vapor is routed to at least one auxiliary consumer to manage the pressure build-up in the LNG tank, the composition of the LNG fuel that is eventually routed to the main consumer may have been changed due to the removal of LNG vapors from the system.

In one example of a supply operation in accordance with the present disclosure, LNG vapor is not routed through at least one Auxiliary Consumer (5) to manage the pressure build-up in the LNG Tank (1). Instead, the LNG vapor in the LNG Tank (1) is cooled by the introduction of subcooled LNG into the LNG Tank (1). Thus, the LNG fuel that is eventually routed to the Main Consumer (7) is the same, or nearly the same, as the LNG fuel composition that was initially transferred into the LNG Tank (1).

Elimination of the Auxiliary Consumers (5) could effectively lower the overall cost of an LNG fuel gas supply and transfer system by eliminating various components traditionally required for routing LNG vapor to the Auxiliary Consumers (5), such as: GVU units, control valves, double wall piping, and labor and installation costs. Additional components that may be eliminated by using the vapor management system and method described herein, include: a boil-off gas preheater and corresponding utilities for the preheater, gas suction separator, the Vapor Compressor (4) and corresponding utilities to support the Vapor Compressor (4), a low pressure LNG vaporizer and corresponding utilities to support the vaporizer, a post-compressor separator and utilities to support the separator, a fuel gas heater cooler, a fuel gas buffer tank and corresponding utilities, and labor and installation costs.

In an LNG fueled transporter where LNG is a secondary fuel and the engine reverts to diesel in Safety Mode, the vapor management method and system proposed by the present disclosure could eliminate a number of redundancy requirements. For example, a redundant high pressure pump and corresponding utilities could be eliminated, representing significant savings.

It should be understood by a person skilled in the art that the various embodiments of the fuel gas supply and transfer system may be used in a variety of arrangements. For example, the auxiliary consumer line (see FIG. 3) may be included on the LNG fueled transporter to provide a redundant vapor management system.

Furthermore, a person skilled in the art will appreciate that reference to an LNG fueled means of transport in the present disclosure should be interpreted to include transport by air (e.g., plane), land (e.g., rail, trucks, and cars), and water (e.g., cruise ships, tankers, bulkers, container vessels, ferries, barges, and tug boats).

Utilising sub-cooling according to the present disclosure on board of gas fuelled vessels would avoid the gradual compositional change of the liquefied gas. By sub-cooling LNG form the tank and then reintroducing the sub-cooled LNG into the vapor space of the same LNG fuel tank the vapor can be directly cooled, thereby reducing the vapor pressure in the tank without the need to remove gas. The system of the disclosure enables complete avoidance of boil-off gas during transport. This may obviate vapor removal and will ensure consistent LNG composition throughout the lifecycle of the LNG fuel while in the LNG fuelled system. The solution will additionally allow engine manufacturers to tighten the expected range of gas compositions, allowing manufacturing costs of components to be significantly reduced and engine performance increased. Additionally, this solution ensures LNG being consumed will only happen for useful work and not consumed just to manage tank pressure.

The present disclosure is application of LNG subcooling technology to LNG fueled vessel fuel gas systems. By subcooling LNG and reintroducing the liquid through a spray header in the vapor space of a LNG fueled vessel tank, the vapor is cooled thereby reducing vapor pressure. This will allow constant and continuous management of vapor. Additionally the liquid will eventually reduce in temperature thereby not allowing boil off gas to occur. This will allow transfers of LNG to the receiving fuel tank in a safer, more rapid, and less complex manner. Additionally, by subcooling liquid LNG and reintroducing to the fuel tank it will ensure that the gas composition of the LNG will remain unchanged during its life within the fuel tank. Additionally, by utilizing a subcooler removal of external vapor management equipment is made possible thereby allowing for less complex and more cost effective LNG fuel gas systems. Additionally this invention will be able to maintain the gas composition and subsequent calorific value of the product. Utilization of this system on gas fueled vessels will also allow for greenhouse gas emissions to be optimized.

The present disclosure is well adapted to attain the ends and advantages mentioned as well as those that are inherent therein. The particular embodiments disclosed above are illustrative only, as embodiments of the present disclosure may be modified and practiced in different but equivalent manners apparent to those skilled in the art having the benefit of the teachings herein. Features of respective embodiments may for instance be combined, within the scope of the appended claims.

1. A method of fueling a transporter with liquefied fuel gas, the method comprising the steps of:
providing a transporter, the transporter comprising a fuel gas storage tank for holding a liquefied fuel gas, a sub-cooler fluidly connected to the fuel gas storage tank, and a consumer;
pumping liquefied fuel gas from the fuel gas storage tank into the sub-cooler to create subcooled liquefied fuel gas; and
introducing the subcooled liquefied fuel gas into the fuel gas storage tank.

2. The method of claim 1, the step of introducing the subcooled liquefied fuel gas into the fuel gas storage tank comprising spraying the subcooled liquefied fuel gas into a vapor space of the fuel gas storage tank.

3. The method of claim 1, further comprising the steps of:
pumping the liquefied fuel gas from the fuel gas storage tank to provide pressurized liquefied fuel gas;
vaporizing the pressurized liquefied fuel gas to provide vaporized fuel gas; and
providing the vaporized fuel gas to the consumer for propelling the means of transport using the vaporized fuel gas as a fuel.

4. The method of claim 1, the method including repeating the steps of pumping the liquefied fuel gas from the fuel gas storage tank into the subcooler to create subcooled liquefied fuel gas; and introducing the subcooled liquefied fuel gas into the fuel gas storage tank to maintain a calorific value of the liquefied fuel gas in the fuel gas storage tank within 15% of a predetermined calorific value.

5. The method of claim 1, the method including repeating the steps of pumping the liquefied fuel gas from the fuel gas storage tank into the subcooler to create subcooled liquefied fuel gas; and introducing the subcooled liquefied fuel gas into the fuel gas storage tank to maintain a calorific value of the liquefied fuel gas in the fuel gas storage tank within 1% of a predetermined calorific value over a time period exceeding 100 days.

6. The method of claim 1, the liquefied fuel gas being LNG.

7. The method of claim 6, the method including repeating the steps of pumping the LNG from the fuel gas storage tank into the subcooler to create subcooled LNG and introducing the subcooled LNG into the fuel gas storage tank to maintain a methane number (MN) of the LNG in the fuel gas storage tank within 2% of a predetermined methane number over a time period.

8. The method of claim 7, the time period exceeding 100 days.

9. The method of claim 1, wherein the method does not include powering auxiliary consumers to reduce the boil-off rate of the liquefied fuel gas.

10. The method of claim 1, wherein the liquefied fuel gas is selected from a group consisting of LNG (liquefied natural gas), LPG (liquefied petroleum gas), and LEG (liquefied ethylene gas).

11. The method of claim 1, comprising the further steps of:
monitoring the temperature of the liquefied fuel gas in the fuel gas storage tank;
introducing the subcooled liquefied fuel gas into the fuel gas storage tank when said temperature exceeds a predetermined upper threshold; and
stopping with introducing the subcooled liquefied fuel gas into the fuel gas storage tank when said temperature drops below a lower threshold.

12. The method of claim 11, the upper threshold being about 0.25° C. below a boiling temperature of the liquefied fuel gas.

13. The method of claim 11, the lower threshold being about 1° C. below a boiling temperature of the liquefied fuel gas.

14. A transporter, comprising:
a fuel gas storage tank for holding a liquefied fuel gas;
a sub-cooler fluidly connected to the fuel gas storage tank to provide subcooled liquefied fuel gas and re-introduce the subcooled liquefied fuel gas into the fuel gas storage tank; and
a consumer.

15. The transporter of claim 14, further comprising:
a pump for pumping the liquefied fuel gas from the fuel gas storage tank to provide pressurized liquefied fuel gas;
a vaporizer for vaporizing the pressurized liquefied fuel gas to provide vaporized fuel gas; and
the consumer comprising an engine using the vaporized fuel gas as a fuel for propelling the transporter.

16. The transporter of claim 14, the consumer being a gas fueled engine adapted to power the transporter.

17. The transporter of claim 14, the transporter being selected from the group of transport vessels, trains, and trucks.

18. The transporter of claim 14, the liquefied fuel gas being selected from the group consisting of LNG (liquefied natural gas), LPG (liquefied petroleum gas), and LEG (liquefied ethylene gas).

19. The transporter of claim 14, comprising a spray header arranged in the fuel gas storage tank for spraying the subcooled liquefied fuel gas into the fuel gas storage tank

20. The transporter of claim 14, the sub-cooler comprising a compressor, a turbine, a first heat exchanger, and a second heat exchanger

21. The transporter of claim 20, the sub-cooler being adapted to use a closed Brayton refrigeration cycle.

22. The transporter of claim 20, the sub-cooler being adapted to use a Turbo-Brayton refrigeration cycle.

23. A subcooling system for fueling a transporter with liquefied fuel gas, comprising:
a transporter, the transporter comprising a fuel gas storage tank for holding a liquefied fuel gas and a consumer, with a sub-cooler;
the sub-cooler fluidly connected to the fuel gas storage tank;
a first pump for pumping liquefied fuel gas from the fuel gas storage tank into the sub-cooler to create subcooled liquefied fuel gas; and
a second pump for pumping the subcooled liquefied fuel gas into the fuel gas storage tank.
